(19) United States
(12) Patent Application Publication
(10) Pub. No.: US 2016/0368800 A1
(43) Pub. Date: Dec. 22, 2016

(54) SUBSEA SEAWATER FILTRATION AND TREATMENT SYSTEM

(71) Applicant: FMC KONGSBERG SUBSEA AS, Kongsberg (NO)

(72) Inventors: Steinar Eriksen, Hokksund (NO); Håkon Bruun, Hyggen (NO); Stein Vegard Larsen, Lier (NO); Terje Hollingsæter, Lommedalen (NO)

(21) Appl. No.: 14/901,232

(22) PCT Filed: Jun. 23, 2014
(86) PCT No.: PCT/EP2014/063118

§ 371 Date: Dec. 28, 2015

(30) Foreign Application Priority Data
Jun. 24, 2013 (NO) 20130877

(51) Int. Cl. C02F 9/00; C02F 1/44; E21B 36/00; B01D 65/02; E21B 43/20; E21B 43/01; B01D 61/02; B01D 61/18

(52) U.S. Cl. CPC C02F 9/00; B01D 61/022; B01D 61/027; C02F 1/442; B01D 61/18; B01D 65/02; E21B 43/20; E21B 43/01; E21B 36/001; C02F 2101/101

(57) ABSTRACT

The present invention provides subsea seawater filtration and treatment system, comprising a filtration assembly (1,3) for filtering out particles and detritus from the seawater; a first pump (5) comprising an inlet in fluid communication with the filtration assembly (1,3) and an outlet; a sulphate removal unit (6) comprising an inlet in fluid communication with the outlet of the first pump (5), a first fraction outlet for sulphate depleted seawater and a second fraction outlet for sulphate enriched seawater; at least one second pump (7) comprising an inlet in fluid communication with the first fraction outlet, and an outlet for the sulphate depleted seawater; wherein the second fraction outlet is in fluid communication with the filtration assembly (1,3), such that the sulphate enriched seawater may be used for backwashing at least a part of the filtration assembly during use.

### FIELD OF THE INVENTION

The present invention concerns a subsea system for seawater treatment, specifically a subsea system for removal of sulphate from seawater. The seawater so treated is suitable for subsequent injection into a reservoir for pressure support.

### BACKGROUND OF THE INVENTION

Water injection into a reservoir to support its pressure is commonly used to increase the production of hydrocarbons from the reservoir. Offshore, a possible source of fluid for injection is seawater.

The quality of the water for injection is required to be of a standard that will not cause problems such as plugging and/or scaling, both in the injection equipment and the reservoir.

A sulphate removal system provides seawater which may be injected into the reservoir to enhance oil recovery (EOR) by maintaining the reservoir pressure and sweeping displaced oil towards the production wells. Seawater typically contains 2,650 mg/l of sulphate ions. Formation water in the reservoir will contain barium in a typical amount of 200 mg/l to a high of 2,500 mg/l. Barium will react with sulphate ions present in injected seawater and cause barium sulphate scale.

The industry recognized solution is to remove sulphate from sea water before injection; this also helps prevent well souring by controlling sulphate reducing bacteria (SRB).

The presently used systems for removal of sulphates from seawater are arranged topside on a rig or vessel. The sulphates are removed from the seawater by the use of nano-filtration membranes, which provide two water fractions, one depleted of sulphates and one enriched in sulphates. The enriched water fraction is discharged to the sea, while the depleted fraction is injected into the oil/gas reservoir. Such prior art systems may need extensive maintenance and are not suitable for installation subsea. In addition, filtration and treatment systems are large and the costs saved by locating the system subsea, and thereby avoiding large installations topside on a rig or vessel, are significant. A further advantage obtained by a subsea system is that it avoids the need for a pipeline from the topside to the reservoir. For instance, in arctic environments connections from the topside to the reservoir may need to be severed due to drifting icebergs.

The goal of the present invention is to provide a subsea system for removal of sulphates from seawater, thereby providing sulphate depleted seawater for subsequent injection into an oil/gas reservoir.

### SUMMARY OF THE INVENTION

The present invention provides a subsea system for removal of sulphates from seawater. The sulphate depleted seawater thus obtained is suitable for subsequent injection into an oil/gas reservoir. The system is defined in the attached claims, and in the following:

In one aspect, the present invention provides a subsea seawater filtration and treatment system, comprising:
a filtration assembly for filtering out particles and detritus from the seawater;
a first pump comprising an inlet in fluid communication with the filtration assembly and an outlet;
a sulphate removal unit comprising an inlet in fluid communication with the outlet of the first pump, a first fraction outlet for sulphate depleted seawater and a second fraction outlet for sulphate enriched seawater;
at least one second pump comprising an inlet in fluid communication with the first fraction outlet and an outlet for the sulphate depleted seawater;
wherein the second fraction outlet is in fluid communication with the filtration assembly such that the sulphate enriched seawater may be used for backwashing at least a part of the filtration assembly during use.

The first pump and the second pump may be separate pumps or comprise an assembly providing two different pump stages. Each pump or pump stage may be run by a common motor or by a separate motor for each pump or stage. When the pumps or pump stages are run by a common motor, they may be connected to said motor by a common shaft, or the motor may drive a separate shaft for each pump or pump stage.

In a further aspect of the subsea system according to the invention, the filtration assembly comprises a coarse filtration unit and a fine filtration unit, the coarse filtration unit being arranged upstream of the fine filtration unit, wherein at least a part of the seawater from the second fraction outlet is guided to backwash at least a segment of the fine filtration unit.

In another aspect of the subsea system according to the invention, the filtration assembly comprises a coarse filtration unit and a fine filtration unit, the coarse filtration unit being arranged upstream of the fine filtration unit, wherein at least a part of the seawater from the second fraction outlet is guided to assist in backwashing the coarse filtration unit.

In another aspect of the subsea system according to the invention, the fine filtration unit comprises multiple filter cartridges and the second fraction outlet is in fluid communication with the fine filtration unit such that the sulphate enriched seawater may backwash at least one of the filter cartridges while the remaining cartridges are in operation. The use of multiple filter cartridges allows for backwashing of only a part of the fine filter unit at a time, while the remaining part of the fine filter unit continues to filter incoming seawater so that the system remains in operation during the backwashing procedure. A further advantage of backwashing only parts of the fine filter unit at a time is made clear when one considers the flow of seawater in the system. In the sulphate removal unit only a part of the incoming seawater is depleted of sulphates. Assuming about 50% of the incoming seawater is depleted in sulphates, the available amount of seawater for backwashing (the sulphate enriched seawater exiting the second fraction outlet) is thus about 50% of the incoming seawater. By for instance backwashing only a third of the fine filtration unit at a time, as is the case if the fine filter unit has three filter cartridges and only one is backwashed, the backwash flow of the sulphate depleted seawater may be almost the same as, or even higher than, the normal flow through the filter in the opposite direction. According to the invention the fine filtration unit may have more than three cartridges, for instance six, and be provided with a system where two, or three or four cartridges are backwashed while the remaining cartridges are in operation. The system may have several cartridges and a piping system connected to the cartridges to allow normal filtering operation and backwashing of the cartridges, with the flexibility to switch between at least these two modes for each cartridge, independent of the remaining cartridges, and possibly also a standby mode. This offers the possibility of having some cartridges in operation to provide seawater to the treatment unit, while the other cartridge(s) are backwashed or in a standby mode, thereby obtaining a continuous operation of the seawater filtering and treatment system. The number of cartridges and the division between cartridges in operation, backwash and possible standby mode will depend on the amount of water needed for injection.

In another aspect of the subsea system according to the invention, the coarse filtration unit is in fluid communication with the second fraction outlet via an ejector, such that the flow of at least a part of the sulphate enriched seawater is a driving fluid in the ejector that provides suction for backwashing the coarse filtration unit. Commonly used coarse filtration units with a backwash system require an internal pressure in a backwash line lower than the normal pressure within the coarse filtration unit to obtain an efficient backwash. With a line with pressure below normal operation pressure within the filtration unit, fluid will flow into the low pressure line and one may thereby have backwash through the filter. By use of an ejector, driven by at least parts of the flow of sulphate depleted seawater, a suction pressure is created in the backwash line of the coarse filtration unit to thereby achieve the above-mentioned requirement without the use of, for instance, an electrically driven pump.

In another aspect of the subsea system according to the invention, the second fraction outlet is in fluid communication with a subsea cooling assembly. At least a part of the second fraction fluid may be guided to the subsea cooling assembly. This part may be taken out of the proposed system directly after the treatment unit. It may be introduced into the second fraction line again further downstream. Alternatively, the entire second fraction may be guided through a cooling system and then guided into a backwashing loop of the filtration assembly. Alternatively, the second fraction fluid may be used for cooling after it has been used to backwash the fine filtration unit and/or the coarse filtration unit. In its simplest form, the second fraction fluid is used to increase the flow of cooling fluid passing a subsea heat-exchanger.

In another aspect of the subsea system according to the invention, the cooling assembly is connected to a motor and/or a variable speed drive/transformer.

In another aspect of the subsea system according to the invention, the cooling assembly is connected to a process fluid heat exchanger.

In another aspect of the subsea system according to the invention, the first pump and the at least one second pump are driven by a common electric motor. The pumps may be a common pump with different pumping stages on a common shaft. Alternatively, pumps may be connected to the same shaft on opposite sides of a common motor.

In yet another aspect, the invention provides a method for subsea filtering and treatment of seawater, comprising the steps of:
filtering the seawater through a filtration assembly;
removing sulphate from the seawater by a sulphate removal unit;
obtaining a first fraction of sulphate depleted seawater and a second fraction of sulphate enriched seawater;
backwashing the filtration assembly by use of at least a part of the second fraction of seawater.

The method according to the invention may comprise the step of injecting the first fraction of seawater into a reservoir.

The method according to the invention may also comprise the step of using at least a part of the second fraction of seawater to provide cooling to a subsea cooling assembly. The cooling assembly may be connected to a motor, a variable speed drive/transformer, and/or a process fluid heat exchanger.

### BRIEF DESCRIPTION OF THE DRAWINGS

The invention is described in more detail by reference to the two embodiments disclosed in the following figures, wherein:

FIG. 1 is a schematic drawing of a system suitable for a single well.

FIG. 2 is a schematic drawing of a system suitable for multiple wells.

### DETAILED DESCRIPTION OF THE INVENTION

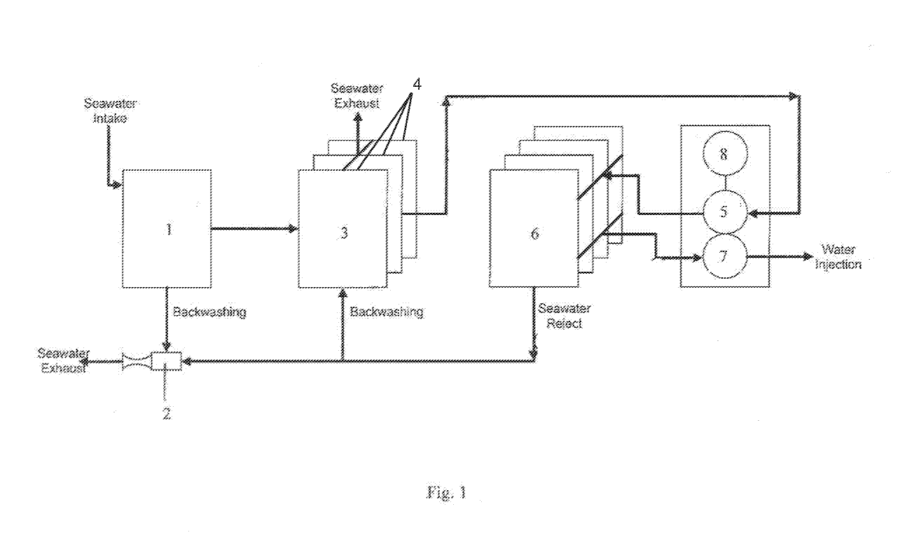

A subsea system suitable for a single well is shown in FIG. 1. The system provides seawater of sufficient purity for injection into a reservoir to provide pressure support. Seawater is first passed through a coarse filtration unit 1 for removal of larger sized particles and materials. The coarse filtration unit 1 may be any suitable unit, provided the filter is adapted for automatic backwash to minimize required maintenance. The pressure difference, or suction, required to obtain a satisfactory backwash is provided by an ejector 2. Following the coarse filtration, the seawater is passed through a fine filtration unit 3 for removal of smaller sized particles. The fine filtration unit 3 comprises several parallel filter cartridges 4; in this particular embodiment the fine filtration unit comprises three such cartridges. The fine filtration unit allows for the cartridges 4 to be brought offline one at a time for backwashing, while the remaining cartridges stay online. A first stage pump 5 provides the necessary pressure for operation of a sulphate removal unit 6. A pressure differential over the pump 5 is usually in the range of 20-50 Bar. The sulphate removal unit 6 comprises nano-filter membranes which retain the sulphates on the high-pressure side, thus providing a first fraction of seawater depleted of sulphates passing through the membrane(s) and a second fraction of seawater enriched in sulphates. The first fraction is injected into a reservoir by a second stage high-pressure pump 7. The pressure increase provided by the pump 7 is typically in the range of 150-250 Bar, but other increases may be required depending on the specific reservoir conditions. The second seawater fraction, having a substantial pressure differential to the surroundings, is subsequently used to backwash the fine filtration unit 3, and further to run the ejector 2. The ejector 2 provides the suction used to backwash the coarse filtration unit 1. The first and second stage pumps 5, 7 shown in FIG. 1 are run by a common electric motor 8. This is achieved either by having a drive shaft being common for both pumps, or by having two separate drive shafts on the motor, each shaft driving a separate pump. The solution of having a common motor 8 is highly advantageous in that it reduces the required topside equipment to only one VSD (variable speed drive), and it requires only one, or a more simple, umbilical as opposed to a solution with two separate motors.

Use of the second fraction of filtered seawater for backwashing the fine filtration unit 3 is also more efficient than using untreated seawater, since the second fraction does not contain any large impurities which could stick on the “clean” side of the fine filter 3. In addition, the use of a third pump for providing pressure to the backwashing is not required since the second fraction is already pressurized by the first stage pump 5. Thus, the second seawater fraction is 1.5 used to obtain backwash of both the fine and the coarse filtration units 1, 3 without requiring any further pumps or motors, while still having enough pressure to be released to sea. These features are especially important in a subsea environment, wherein any additional motor or pump will add significantly to the costs, both during installation and operation.

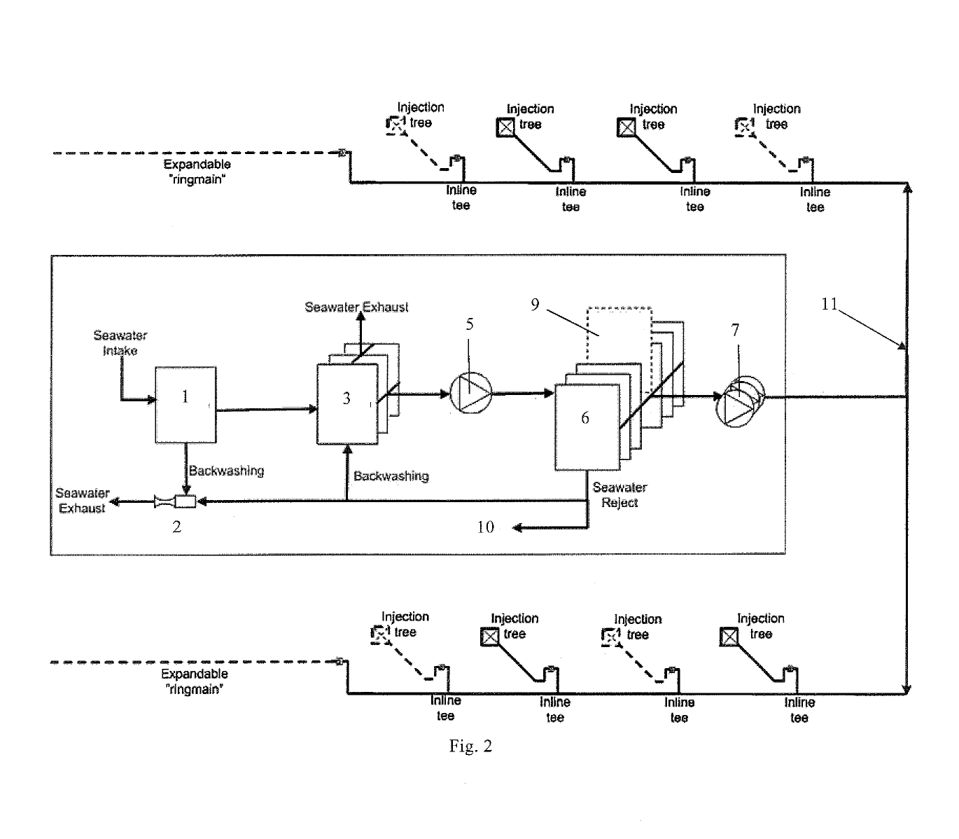

A subsea system similar to the one described in FIG. 1 is shown in FIG. 2. The main difference between the two systems is that the system in FIG. 2 is suitable for providing seawater injection to multiple sites 11. The first seawater fraction is in this case used to inject multiple wells, and/or injection sites, in a reservoir formation. To obtain the required pressure and volume, multiple high-pressure second stage pumps 7 are required.

In addition to providing a fluid for backwashing of the fine filtration unit 3 and driving of the ejector 2 for backwashing the coarse filtration unit 1, at least a part of the second seawater fraction may be used to provide cooling to various subsea equipment 10, such as motors and VSD/Transformers. Cooling of such subsea equipment is commonly obtained by free convective heat transfer to ambient seawater. When calculating the required dimensions of a heat exchanger used for such cooling, the intrinsic seawater flow passing the heat exchanger is set to zero to ensure that an adequate cooling is obtained during any condition. A zero intrinsic flow of seawater means that the movement of the seawater is only due to the heat transfer itself. Even a very slight increase of the intrinsic flow of the seawater, i.e., forced convection, will lead to a large increase in the heat transfer. By using at least a part of the second seawater fraction to increase said intrinsic flow, the dimensions of the heat exchanger may be significantly reduced.

The sulphate removal unit 6 is shown to have multiple retrievable/replaceable cartridges or stacks 9. The possibility for replacing individual cartridges/stacks which do not perfom as required is important in a subsea environment.

1: A subsea seawater filtration and treatment system, comprising:
a filtration assembly for filtering out particles and detritus from the seawater;
a first pump comprising an inlet in fluid communication with the filtration assembly and an outlet;
a sulphate removal unit comprising an inlet in fluid communication with the outlet of the first pump, a first fraction outlet for sulphate depleted seawater and a second fraction outlet for sulphate enriched seawater:
at least one second pump comprising an inlet in fluid communication with the first fraction outlet and an outlet for the sulphate depleted seawater;
wherein the first pump and the at least one second pump are driven by a common electric motor; and
wherein the second fraction outlet is in fluid communication with the filtration assembly, such that the sulphate enriched seawater may be used for backwashing at least a part of the filtration assembly during use.

2: A subsea system according to claim 1, wherein the filtration assembly comprises a coarse filtration unit and a fine filtration unit, the coarse filtration unit being arranged upstream of the fine filtration unit, and wherein at least a part of the sulphate enriched seawater from the second fraction outlet is guided to backwash at least a segment of the fine filtration unit during use.

3: A subsea system according to claim 1, wherein the filtration assembly comprises a coarse filtration unit and a fine filtration unit, the coarse filtration unit being arranged upstream of the fine filtration unit, and wherein at least a part of the seawater from the second fraction outlet is guided to assist in backwashing the coarse filtration unit during use.

4: A subsea system according to claim 2, wherein the fine filtration unit comprises multiple filter cartridges and the second fraction outlet is in fluid communication with the fine filtration unit such that the sulphate enriched seawater may backwash at least one filter cartridge during use while the remaining cartridges are in operation.

5: A subsea system according to claim 3, wherein the coarse filtration unit is in fluid communication with the second fraction outlet via an ejector, such that the flow of at least a part of the sulphate enriched seawater is a driving fluid in the ejector to provide suction for backwashing the coarse filtration unit during use.

6: A subsea system according to claim 1, wherein the second fraction outlet is in fluid communication with a subsea cooling assembly.

7: A subsea system according to claim 6, wherein the cooling assembly is connected to at least one of a motor and a variable speed drive/transformer.

8: A subsea system according to claim 6, wherein the cooling assembly is connected to a process fluid heat exchanger.

9: A method for subsea filtering and treatment of seawater, comprising the steps of:
filtering the seawater through a filtration assembly;
removing sulphate from the seawater using a sulphate removal unit;
to thereby obtain a first fraction of sulphate depleted seawater and a second fraction of sulphate enriched seawater; and
backwashing the filtration assembly using at least a part of the second fraction of seawater.

10: A method according to claim 9, further comprising the step of using at least a part of the second fraction of sulphate enriched seawater to provide cooling to a subsea cooling assembly.

11: A method according to claim 10, wherein the cooling assembly is connected to at least one of motor, a variable speed drive/transformer, and a process fluid heat exchanger.
